(19) United States
(12) Patent Application Publication
(10) Pub. No.: US 2008/0141551 A1
(43) Pub. Date: Jun. 19, 2008

(54) Penny's portable compact hair dry/vacuum

(76) Inventor: Pauline Brown-Carter, Wellington, FL (US)

Correspondence Address: Pauline Brown Carter, 11329 Regatta LN, Wellington, FL, 33467, US

(21) Appl. No.: 11/346,433

(22) Filed: Dec. 19, 2006

(51) Int. Cl. F26B 13/30; A45D 20/00

(52) U.S. Cl. 34/92; 34/96

(57) ABSTRACT

A new combination hair dryer/vacuum that will permit vacuuming of debris using the same device.

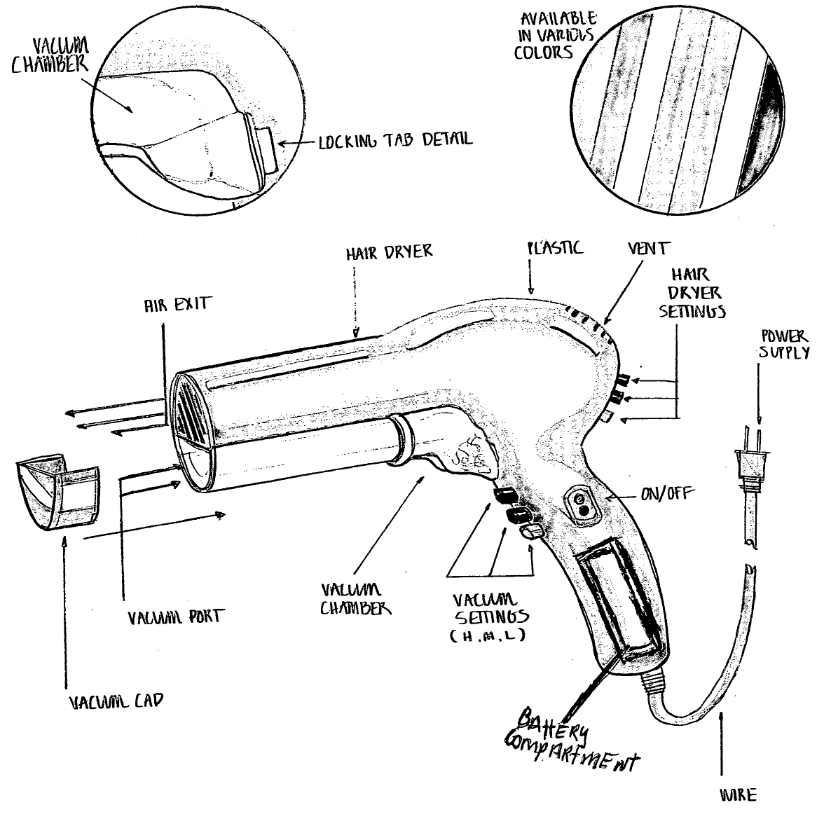

The inventors device includes a tubular main member as the hair dryer and the same structures as the vacuum and handle. The tubular main member has a hollow interior and operates by heat elements. The vacuum member of this device operates by suction. This device operates by electric or batteries and has three settings low, medium, and high.

The Penny's Hair Dryer/Vacuum is made from readily available inexpensive materials: durable plastic, metal and electrical elements.

Each unit of this device has adjustable speed and a safety cover for the vacuum chamber. This device is very easy to handle and operate.

1. I Pauline Brown Carter inventor of the Penny's Hair Dryer/Vacuum claim that this device will revolutionize the way fallen hair is removed from counter tops, floors around the chair and other surfaces where hair is likely to be left.
A.) This device is made from plastic, it is light weight and very easy to handle. It also comes in various colors.
B.) It can be operated by electric or batteries which makes it more desirable. The vacuum chamber of this device has a safety cover. Each unit is equipped with adjustable speeds.
C.) This device is designed to be used at home, barber shops, pet shops and beauty salons.
The user of this product will no longer need to look for some thing to clean up fallen hair.
